(19) United States
(12) Patent Application Publication
(10) Pub. No.: US 2021/0375045 A1
(43) Pub. Date: Dec. 2, 2021

(54) SYSTEM AND METHOD FOR RECONSTRUCTING A 3D HUMAN BODY UNDER CLOTHING

(71) Applicant: VIETTEL GROUP, Ha Noi City (VN)

(72) Inventors: Xuan Canh Cao, Uong Bi City (VN); Tien Dat Nguyen, Ha Noi City (VN); Hai Anh Nguyen, Ha Noi City (VN); Van Duc Tran, Kien Xuong District (VN)

(73) Assignee: VIETTEL GROUP, Ha Noi City (VN)

(21) Appl. No.: 17/115,697

(22) Filed: Dec. 8, 2020

(30) Foreign Application Priority Data
May 29, 2020 (VN) 1-2020-03069

(51) Int. Cl. G06T 17/20; G06T 7/70; G06T 7/11; G06T 19/20; G06N 20/00; G06N 5/04

(52) U.S. Cl. CPC G06T 17/20; G06T 7/70; G06T 7/11; G06T 19/20; G06T 2219/2021; G06N 5/04; G06T 2207/20081; G06T 2207/30196; G06T 2207/10024; G06N 20/00

(57) ABSTRACT

The invention presents a system and a method for digitizing body shape from dressed human image using machine learning and optimization techniques. The invention is able to rapidly and accurately reconstruct human body shape without using costly, bulky and hazardous 3D scanners. Firstly, the system reconstructing human body shape from the dressed human image includes 2 main modules and 2 supplementary blocks, which are: (1) Input Block, (2) Pre-Processing Module, (3) Optimization Module, (4) Output Block. In which, the Pre-Processing Module comprises 4 blocks: (1) Image Standardization, (2) Clothes Classification and Segmentation, (3) Human Pose Estimation, (4) Cloth-Skin Displacement Model. The Optimization Modules comprises 2 blocks: (1) Human Parametric Model, (2) Human Parametric Optimization. Secondly, the method for reconstructing body shape from dressed human image includes 4 steps: (1) Collecting dressed human images, (2) Standardizing and extracting image information, (3) Parameterizing and optimizing human shape, (4) Displaying human body shape.

### FIELD OF THE INVENTION

The Invention relates to a system and a method for digitizing the human body under clothing. Machine learning techniques and optimal algorithms in applied simulation technologies are utilized for this invention.

### BACKGROUND

The invention regarding reconstructing a human body under clothing, presents a new method for designing and building a digital version of the human body. Typically, traditional methods use a 3D scanning system based on technologies such as Laser Triangulation; Photogrammetry and Structured Light for 3D digitalization of the human body. These systems exploit users' image data or point cloud data obtained by depth cameras to build digitalized versions of people. An overview of the traditional method model is shown in FIG. 1.

However, traditional methods face noticeable challenges. Firstly, the digitalized person here is required to wear tight clothes to capture his actual body shape, causing an inconvenient, time-consuming and impractical 3D body scanning process. Secondly, current methods are only able to create the 3D human shape and extract its measurements but almost incapable of simulating its movement, which is essential for practical applications. Therefore, a method for digitalizing the human body which allows a digitalized person to wear casual outfits and simulates not only his shape but also his pose and movement is necessary to better satisfy actual requirements.

Thirdly, traditional methods require time for data processing. In particular, regarding Laser Triangulation technology, point clouds obtained after scanning need to be processed by specific software to create a 3D model, which is very time-consuming. Fourthly, installing Photogrammetry and Structured light systems is timely and costly (about $100,000). Finally, 3D body scanning systems, which use special lighting to capture different sides of the body simultaneously could be hazardous to human health. Taking all above problems into account, machine learning techniques are presented to increase processing speed, reduce implementation costs, optimize space utilization and preserve the digitalized person from harmful lights. These techniques are expected to have a wide application in various fields.

### SUMMARY OF THE INVENTION

The first purpose of the invention is to propose a system for digitalizing body shape of human body shape under clothing based on machine learning techniques and optimal algorithms on RGB image data. In which, machine learning techniques are used to: first, classify and segment clothing region; second, estimate skeleton joint locations and postures; third, detect human region and background region in the image and fourth, ensure the proportion of human body parts according to the human race. The optimal algorithm is used to generate three-dimensional human body data that matches the information obtained from the image.

To achieve the above purpose, proposed system and method include 2 main modules: (1) Pre-Processing Module, (2) Optimization Module, and 2 supplementary blocks: (1) Input Block, (2) Output Block. In particular, the Pre-processing Module collects image data and image information for the Optimization Module. Specifically, the Pre-processing Module includes four components as follows: (1) Image Standardization Block: standardizing input images for processing in next steps; (2) Clothes Classification and Segmentation Block: using machine learning techniques to identify, classify and locate clothes appearing in the RGB images; (3) Human Pose Estimation Block: Using machine learning methods to recognize human posture in the standardized image inputted; (4) Cloth-Skin Displacement Block: using cloth-skin displacement probability distribution in different types of clothing to estimate the distance between clothes and human skin surface.

The posture, clothing type and distance distribution information in the Preprocessing Module are input data for the Optimization Module. In which, the Optimization Module consists of 2 main components: (1) Human Parametric Model: simulating various forms and poses of human via Parameters controlling the shape (tall, short, thin, fat . . . ) and Parameters controlling the pose (standing, sitting, arms spreading . . . ), thereby morphing a parametric 3D model into a real human 3D model; (2) Human Parametric Optimization: optimizing postural and shape parameters corresponding with information received from the Preprocessing Module to transform the parametric model into a model approximate to the real human shape.

The second purpose of the invention is to propose a method for digitalizing a human body shape under clothing based on machine learning and optimization algorithms on RGB image data. To this end, the proposed method consists of four steps: (1) Step 1: Collecting dressed human image; (2) Step 2: Standardizing and extracting image information; (3) Step 3: Developing a parametric model and optimizing parameters; (4) Step 4: Displaying the digitized human body model.

### BRIEF DESCRIPTION OF THE DRAWINGS

FIG. 1 is a block diagram illustrating the 3D digitalization of human body shape in traditional methods.

FIG. 2 is a block diagram illustrating the 3D digitalization of human body shape in the invention.

FIG. 3 illustrates the Preprocessing Module;

FIG. 4 illustrates the Optimization Module;

FIG. 5 is a flowchart that illustrates 4 mains steps of the method.

### DETAILED DESCRIPTION OF THE INVENTION

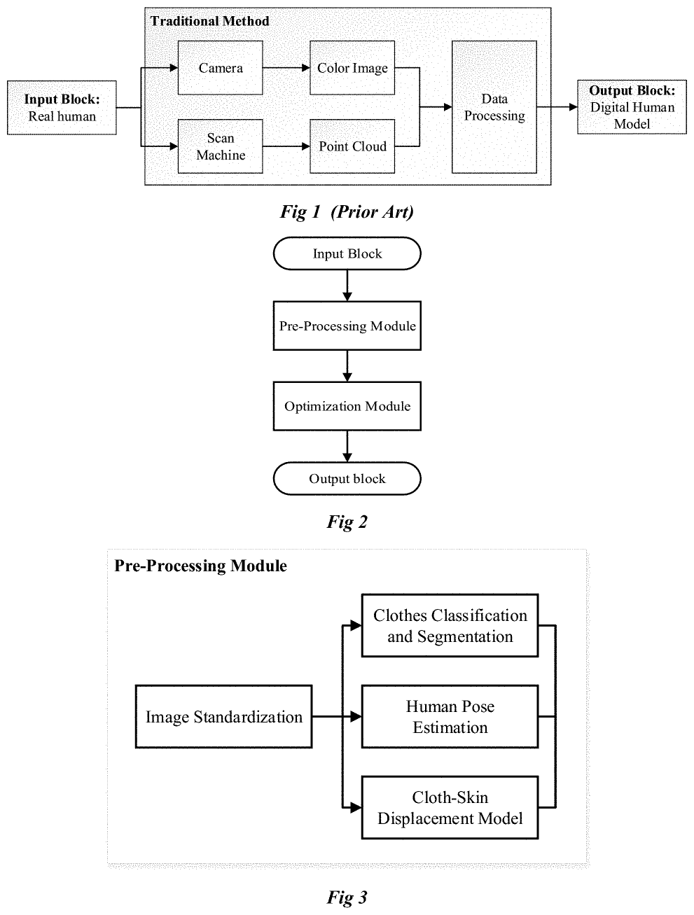

As shown in FIGS. 1 and 2, the invention refers to a system and a method for digitizing the human body under clothing using machine learning techniques and optimization algorithms.

In this invention, following terms are construed as below:

“Digitized human body model” or “Digital human model” is data that uses laws of mesh points, mesh surfaces to represent a three-dimension shape of a real person's body shape. That means all shape sizes are preserved from the real body. In addition, a digital human model utilizes reference key points as well in order to present human joints, thereby controlling the posture of the digital human model. This data is saved as FBX format—a format used to exchange 3D geometry and animation data. FBX files can store various data including bones, meshes, lighting, camera, and geometry, etc. to complete animation scenes. This file format supports geometry and appearance related to properties like color and texture. It also supports skeletal animations and morphs. Both binary and ASCII files are supported.

“Human joint” is a point physically connecting bones in the body to form a complete skeletal system of a functional human body.

“Clothes classification and segmentation” is a process to classify the clothes type/label, background, skin, hair and identify its area location in the image

“Clothes type” or “type of clothing” in the proposed technique includes 11 categories: image background, skin, hair, innerwear, outerwear, skirt, dress, pants, shoes, bag, and others.

“Cloth-skin displacement probability distribution” is the statistical probability of the occurrence of a distance between the clothing surface of each clothes type and human skin surface.

“Machine learning techniques” used in the proposed method are techniques which, firstly, extract image characteristics and secondly, learn to suggest models for predicting, classifying, determining and constraining properties including: type of clothing, region of clothing, human and background in the image, location of joints and the human race.

“Optimization algorithms” refer to adjusting the pose and shape parameters to morph a human parametric model to matches the body information obtained from the image.

A “human parametric model” is a model that could simulate various forms and poses of humans via shape parameters controlling the shape (tall, short, thin, fat . . . ) and parameters controlling the pose (standing, sitting, arms spreading . . . ). It creates rules for number of mesh points, type of meshes, index of mesh surfaces and location of joint points that digitizing the human body has to comply with.

FIG. 2 indicates the difference between traditional and proposed system regarding digitalizing the human body shape. The latter uses image input obtained only from RGB camera, processing the data through two main modules instead of just processing data from the information-rich input: (1) Pre-processing module; (2) Optimization module like the former. In which, module 1 (Pre-Processing) is responsible for collecting image data and exporting information from that images, including location of skeleton joints, region of clothing, type of clothing and probability distribution for each type of clothing. The Optimization Module uses this exported information as input data to generate 3D human models satisfying information from the image. The main modules and supporting blocks are presented in detail as follows:

Input Block

The main function of the Input block is to collect color images taken by hardware devices such as cameras, camcorders, IP cameras, smartphones, scanners or any other devices that can capture a color image. These images are raw data for the Pre-processing module before the implementation of the digitizing human body.

Pre-Processing Module:

Referring to FIG. 3, Pre-Processing Module aims to standardize and extract information from RGB images as input data to Optimization Module. In particular, an Image Standardization Block collects and adjusts RGB images which have been standardize by image size, brightness, distortion, topological uniformity and other criteria. Using these images, this block simultaneously estimates internal and external camera parameters which denote camera properties such as focal length, position and center point. In the next step, standardized images are processed in 3 blocks to extract information about clothes classification and segmentation, cloth-skin displacement, pose estimation which is then supplied to Optimization Module.

First extractor block (called Clothes Classification and Segmentation) is developed by using machine learning techniques to classify the clothes type and identify its position in the image. Machine learning techniques are applied to learn how to do clothes classification and segmentation on a large dataset of image including defined clothes region and its name tag. Then, a learned model is able to predict clothes type and position in a new image reliably. In this block, 11 specific objects are classified and identified, including background, skin, hair, inner clothes, outer clothes, dress, sheath dress, bag, shoes and others.

Second extractor block (called Human Pose Estimation) uses the same method as the first block to identify joints in different body parts of the object in the standardized image, including head, neck, shoulder (left, right), elbow (left, right), wrist (left, right), spine, hip (left, right), knee (left, right), ankle (left, right), foot (left, right). Identified joint positions are used to reconstruct the human pose.

Third extractor block (called Cloth-skin Displacement Model) is built based on cloth-skin displacement probability distribution of each clothes type. The purpose of this block is to estimate the distance between clothes and skin, thereby estimating the human shape under clothing more accurately. Cloth-skin displacement model is developed by using a large dataset (pairs of people with and without clothes) as well.

Optimization Module

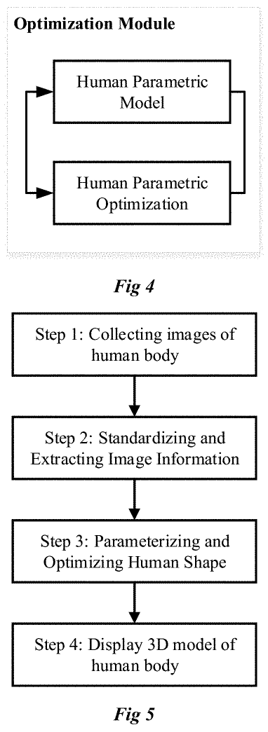

As illustrated in FIG. 4, the Optimization Module consists of 2 major components: (1) Human Parametric Model: simulating various forms and poses of humans via parameters controlling the shape (tall, short, thin, fat, etc) and parameters controlling the pose (standing, sitting, arms spreading, etc), thereby morphing a parametric 3D model into a real human 3D model; (2) Human Parametric Optimization: optimizing postural and shape parameters (corresponding with information received from the Preprocessing Module) to transform the parametric model into a model approximate to the real human shape.

Output Block

Main function of Output Block is to display final results in the form of a mesh model (.fbx) following standard of vertex and face number. The final result can be shown on computer screen, projector screen or other similar hardware devices.

Referring to FIG. 5, the method for digitalizing body shape of dressed-human silhouettes using Machine Learning and Optimization Techniques includes 4 main steps as follows:

Step 1: Collecting Dressed-Human Images

In this step, dressed-human image is taken by hardware devices (like camera). Then, these collected images are sent to Pre-Processing Module for information extraction in Step 2

Step 2: Standardizing and Extracting Image Information

The input images are adjusted by several standards such as image size, brightness, distortion, topological uniformity. Internal and external camera parameters are determined as well.

First extractor block (called Clothes Classification and Segmentation) uses machine learning techniques to classify and segment clothes based on inputted standardized images. These machine learning algorithms are developed by training a large dataset of images including defined cloth region and its label that would automatically identify similar region and label when browsing a new input image. There are 11 labeled regions including background, skin, hair, inner clothes, outer clothes, dress, sheath dress, bag, shoes and others.

Second extractor block (called Human Pose Estimation) uses the same method as the first block to identify joints in different body parts of the object in the standardized image, including head, neck, shoulder (left, right), elbow (left, right), wrist (left, right), spine, hip (left, right), knee (left, right), ankle (left, right), foot (left, right). Joint positions acquired are used to reconstruct the human pose.

Third extractor block (called Cloth-skin Displacement Model) is built based on cloth-skin displacement probability distribution of each clothes type. The purpose of this block is to estimate the distance between clothes and skin, thereby estimating the human shape under clothing more accurately

Step 3: Parameterizing and Optimizing the Human Parametric Model

Given the joint locations, clothes classification and segmentation and probability distribution for each clothes type that have been identified in previous step, this step determines parameters of the 3D human model so that its pose and shape information satisfy the information in Pre-processing Module. The process of optimization is performed by minimizing the objective function E(β,θ) as follows:

E(β,θ)=λ_{J}E_{J}(β,θ,K,Jₑₛₜ)+λ_{S}E_{S}(β,θ)+λ_{C}E_{C}(β,θ)

In which:
β, θ: denoting pose and shape parameters of human parametric model
λ_{J}, λ_{S}, λ_{C}: are scalar weights corresponding to each sub-objective functions.
   The objective function E(β,θ) is sum of 03 sub-objective functions:
1.

$${E}_{J} ( β , θ , K , {J}_{e s t} ) = \sum ( {Π}_{K} ( {R}_{M} ) - {J}_{est , i} \text{):}$$

2D distance between joint locations of real human in image determined by Pre-processing Module and the projection of 3D joints of human parametric model. Π_{K} is perspective projection of joints in three dimensional (R_{M}) on the image, K denotes the camera parameters.
2.

$${E}_{S} ( β , θ ) = {\sum }_{C} ( \frac{1}{{n}_{c}} {\sum }_{c ∈ C} ‖ {p}_{c} - N {N}_{S M P L , c} ( {p}_{c} ) ‖ )$$

penalty error between boundary contour of real human and the projection of the SMPL model. Where: c∈C, C is a set of cloth segmentation, C={skirt, skin, hair, . . . }; p_{c} denotes points in boundary contour of parts in input image; NN_{SMPL,c}(p_{c}) denotes points in boundary contour of projected SMPL model that is nearest from p_{c}; n_{c} denotes the number of points in boundary contour of part c.
3.

$${E}_{C} ( β , θ ) = \frac{1}{n} {\sum }_{C} {\sum }_{p} {d}_{p} \text{:}$$

displacement between human skin contour and cloths skin contour. dₚ: 2D distance between point in human skin contour and cloth contour corresponding with cloth type c and sample point p.

The objective function is minimized by applying derivative-free optimization method.

Step 4: displaying 3D model of human body.

In this step, the final result in the form of a mesh model (.fbx) following the standard of vertex and face number can be showed on computer screen, projector screen or other similar hardware devices.

1. A system and a method for reconstructing a 3D human body under clothing, comprising 2 main modules and 2 supporter blocks:
An Input Block for Collecting color images by hardware devices such as IP cameras and smartphones;
A Pre-processing Module for applying machine learning methods to identify information regarding clothes type and human pose based on images collected and adjusted from the input block, wherein this module includes 4 main blocks: an Image Standardization Block, a Clothes Classification and Segmentation Block, a Pose Estimation Block and a Cloth-skin Displacement Block;
An Optimization Module: comprising 2 blocks: (1) a Human Parametric Model that simulates various forms and poses of humans via pose parameters and shape parameters, (2) A Human Parametric Optimization that applies optimization algorithms to transform a parametric model into a model that approximates to a real human shape; and
An Output Block for displaying a final results in a form of a mesh model (.fbx) following a standard of vertex and face number, wherein The final results can be shown on a computer screen, a projector screen or other similar hardware devices.

2. The system and method of claim 1, further comprising:
An Image Standardization block for collecting and adjusting RGB images complying with standards of image size, brightness, distortion, topological uniformity, etc., wherein Using these RGB images, this block simultaneously determines internal and external camera parameters;
A Clothes Classification and Segmentation block using machine learning techniques to learn how to do clothes classification and segmentation on a large dataset of images including defined clothes region and its name tag, wherein 11 specific objects are classified and segmented, including background, skin, hair, inner clothes, outer clothes, dress, sheath dress, bag, shoes and others;
A Human Pose Estimation Block using the same method as the Clothes Classification and Segmentation block to identify joints in different body parts including head, neck, shoulder (left, right), elbow (left, right), wrist (left, right), spine, hip (left, right), knee (left, right), ankle (left, right), foot (left, right), wherein A digital skeleton created by connecting these points would simulate a human pose;
A Cloth-Skin Displacement Block based on cloth-skin displacement probability distribution of each clothes type, wherein this block estimates a distance between clothes and skin, thereby estimating the human shape under clothing more accurately.

3. A method for reconstructing 3D human body under clothing comprising the following steps:
Step 1: collecting images of dressed-human. Images taken by hardware devices and then transferring said images to a Pre-processing Module for step 2;
Step 2: Standardizing and Extracting Image Information: In this step, the collected images are standardized by image size, brightness, distortion, topological uniformity and other criteria; Internal and external camera parameters are estimated;
After standardizing, the image is extracted to classify type and identify region of clothing; This step also finds out and classifies joint locations of the human body, including head, neck, shoulder (left, right), elbow (left, right), wrist (left, right), spine, hip (left, right), knee (left, right), ankle (left, right), foot (left, right); After the clothes type and joint locations are identified, distance between clothing and human skin is estimated.
Step 3: Parameterizing and Optimizing Human Shape: At this step, input parameters including: the joint location on the human skeleton, the segmentation of clothing, the type of clothing and the probability distribution for each clothes type determined from the previous steps is used to build a standard model, containing parameters controlling posture (standing, sitting, extending arms . . . ) and parameters controlling shape (tall, short, thin, fat . . . ); After that, standard human model is transformed into a model approximates to a real human body shape based on optimization of pose and shape parameters to satisfy posture information and classified clothes in the Pre-processing Module; and
Step 4: displaying 3D model of human body, In this step, a final result in form of a mesh model (.fbx) following a standard of vertex and face number is shown on hardware devices such as computer or projector screens.
